(19) United States
(12) Patent Application Publication
(10) Pub. No.: US 2025/0300689 A1
(43) Pub. Date: Sep. 25, 2025

(54) Cell Phone Docking Station Device

(71) Applicant: Michael Reynolds, Fitchburg, MA (US)

(72) Inventor: Michael Reynolds, Fitchburg, MA (US)

(21) Appl. No.: 18/901,547

(22) Filed: Sep. 30, 2024

Related U.S. Application Data
(60) Provisional application No. 63/568,007, filed on Mar. 21, 2024.

(51) Int. Cl. H04B 1/3877; H02J 7/00; H04M 1/04; H04M 1/72409

(52) U.S. Cl. CPC H04B 1/3877; H02J 7/00034; H02J 7/0045; H04M 1/04; H04M 1/72409; H04M 2201/38

(57) ABSTRACT

A cell phone docking station device is provided comprising of a housing designed to hold a smart device, such as a cellphone, wherein the device displays a limited amount of features of the smart device via a display screen. The housing includes an adjustable stand and at least one compartment at the rear, secured by a door, which houses a charging port for wired or wireless charging of the smart device. The charging port also enables electrical communication between the smart device and an external display screen on the housing, which can be programmed to display only essential notifications and features of the smart device (as configured by user). Additional features include audio playback through a speaker, ability to take phone calls using a docked handset, and power supplied by a non-removable or rechargeable battery. The device may also incorporate a transmitter, ie, Bluetooth or Wi-Fi, for smart home integration.

### CROSS-REFERENCE TO RELATED APPLICATION

The present application claims priority to, and the benefit of, U.S. Provisional Application No. 63/568,007, which was filed on Mar. 21, 2024, and is incorporated herein by reference in its entirety.

### FIELD OF THE INVENTION

The present invention relates generally to the field of cell phones. More specifically, the present invention relates to a cell phone docking station device that receives a cell phone and displays a limited number of features and applications from the cell phone on a digital display, allowing a user to maintain necessary cell phone functionality but with limited distractions. Accordingly, the present disclosure makes specific reference thereto. Nonetheless, it is to be appreciated that aspects of the present invention are also equally applicable to other like applications, devices, and methods of manufacture.

### BACKGROUND

As cell phones have become the primary mode of communication for most people, they have also become deeply embedded in nearly every aspect of daily routines. From waking up to the sound of a smartphone alarm to checking the latest news, weather, and emails, cell phones are indispensable tools that facilitate both personal and professional tasks. However, this constant accessibility and reliance on cell devices have significant downsides. One of the most prevalent issues is the tendency for users to spend excessive amounts of time on their phones, often engaging in mindless scrolling through social media feeds, playing games, or using other non-essential applications. This behavior not only consumes valuable time but can also lead to decreased productivity, increased stress, and a diminished ability to concentrate on more important tasks.

For many, the challenge lies in striking a balance between utilizing their cell phones for essential purposes—such as making phone calls, sending and receiving emails, listening to music, or checking the weather—and avoiding the temptation of less productive activities. The idea of turning off the phone entirely is seldom a viable option, as cell devices are a primary means of staying in touch with family, friends, and colleagues. Additionally, for many professionals, the cell phone is an indispensable tool for work, enabling them to respond to urgent emails, participate in virtual meetings, and manage their schedules on the go.

However, the constant influx of notifications and the temptation to check the phone frequently can make it difficult to focus on more meaningful or necessary activities, whether it's completing a work project, spending quality time with loved ones, or simply enjoying a moment of solitude. This has led to a growing recognition of the need for an effective strategy or tool that can help users manage their cell phone usage more mindfully.

Therefore, there exists a long-felt need in the art for a device that can be used to reduce distractions caused by cell phones. There also exists a long-felt need in the art for a cell phone docking station device. Further, there exists a long-felt need in the art for a cell phone docking station device that reduces distractions from cell phones while still allowing a user to access important features of the cell phone. In addition, there exists a long-felt need in the art for a cell phone docking station device that reduces distractions from cell phones while still allowing a user to access important features of the cell phone, wherein the specific features that are accessible can be customized by the user.

The subject matter disclosed and claimed herein, in one embodiment thereof, comprises a cell phone docking station device. The device is comprised of a housing designed to hold a smart device, such as a cellphone, wherein the device displays a limited amount of features of the smart device via a display screen. The housing includes an adjustable stand and at least one compartment at the rear, secured by a door, which houses a charging port for wired or wireless charging of the smart device. The charging port also enables electrical communication between the smart device and an external display screen on the housing, which can be programmed to display only essential notifications and features of the smart device (as configured by the user). Additional features include audio playback through a speaker, the ability to take phone calls using a docked handset, and power supplied by a non-removable or rechargeable battery. The device may also incorporate a transmitter, such as Bluetooth or Wi-Fi, for smart home integration.

In this manner, the cell phone docking station device of the present invention accomplishes all the forgoing objectives and provides a device that can be used to reduce distractions caused by cell phones. More specifically, the device reduces distractions from cell phones by limiting cell phone access, while still allowing a user to access important features of the cell phone through the device. In addition, the specific features of the cell phone that are accessible through the device can be customized by the user.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone docking station device comprised of a housing that receives a smart device such as but not limited to a cellphone. More specifically, the housing is comprised of at least one compartment comprised of at least one door that covers the compartment. The compartment is comprised of at least one charging port positioned within the compartment that charges a smart device placed within the compartment, and also places the smart device in electrical communication with at least one display screen on the housing. The screen can be programmed by a user to display specific applications and/or features of the smart device, such that the user is not distracted by unnecessary applications/features of the smart device, and wherein a user cannot access the smart device when within the compartment. As a result, the device reduces the distractions associated with using a smart device without causing a user to lose out on the important functions of a smart device.

In one embodiment, audio (ex. phone calls, notifications, sounds, etc.) from the smart device can be played via at least one speaker of the housing through electrical communication via the charging port. Volume of the speaker may be controlled and configured by the display and/or at least one button. In one embodiment, a user can take a phone call from the smart device through at least one wired or wireless phone handset removably docked on the housing, wherein the handset is comprised of at least one speaker and at least one microphone. Components of the device are powered by at least one battery.

The present invention is also comprised of a method of using the device. First, a device is provided comprised of housing comprised of a compartment comprised of a charging port, a display screen, and a phone handset. Then, a smart device can be placed inside the compartment and attached to the charging port. Next, a user can close the compartment with the smart device inside via the door and can then secure the door to the housing via a lock. Next, a user can select an application or a feature of the smart device to be shown/accessible from the display screen using the display screen. A user can also use a phone handset of the device to make or answer a phone call from the smart device through the device.

Accordingly, the cell phone docking station device of the present invention is particularly advantageous as it provides a device that can be used to reduce distractions caused by cell phones. More specifically, the device reduces distractions from cell phones by limiting cell phone access, while still allowing a user to access important features of the cell phone through the device. In addition, the specific features of the cell phone that are accessible through the device can be customized by the user. In this manner, the cell phone docking station device overcomes the limitations of existing headstones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a cell phone docking station device of the present invention in accordance with the disclosed architecture;

FIG. 2 illustrates a rear perspective view of one potential embodiment of a cell phone docking station device of the present invention with an open compartment in accordance with the disclosed architecture;

FIG. 3 illustrates a rear perspective view of one potential embodiment of a cell phone docking station device of the present invention with a closed compartment in accordance with the disclosed architecture; and

FIG. 4 illustrates a flowchart of a method of using one potential embodiment of a cell phone docking station device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to reduce distractions caused by cell phones. There also exists a long-felt need in the art for a cell phone docking station device. Further, there exists a long-felt need in the art for a cell phone docking station device that reduces distractions from cell phones while still allowing a user to access important features of the cell phone. In addition, there exists a long-felt need in the art for a cell phone docking station device that reduces distractions from cell phones while still allowing a user to access important features of the cell phone, wherein the specific features that are accessible can be customized by the user.

The present invention, in one exemplary embodiment, is comprised of a cell phone docking station device. The device is comprised of a housing that receives a smart device such as but not limited to a cellphone. More specifically, the housing is comprised of at least one compartment comprised of at least one door that covers the compartment. The compartment is comprised of at least one charging port positioned within the compartment that charges a smart device placed within the compartment. The charging port also places the smart device in electrical communication with at least one display screen on the housing. The screen can be programmed by a user to display specific applications and/or features of the smart device, such that the user is not distracted by unnecessary applications/features of the smart device, and wherein a user cannot access the smart device when within the compartment. As a result, the device reduces the distractions associated with using a smart device without causing a user to lose out on the important functions of a smart device.

In one embodiment, audio (ex. phone calls, notifications, sounds, etc.) from the smart device can be played via at least one speaker of the housing through electrical communication via the charging port. Volume of the speaker may be controlled and configured by the display and/or at least one button. In one embodiment, a user can take a phone call from the smart device through at least one wired or wireless phone handset removably docked on the housing, wherein the handset is comprised of at least one speaker and at least one microphone. Components of the device are powered by at least one battery.

The present invention is also comprised of a method of using the device. First, a device is provided comprised of housing comprised of a compartment comprised of a charging port, a display screen, and a phone handset. Then, a smart device can be placed inside the compartment and attached to the charging port. Next, a user can close the compartment with the smart device inside via the door and can then secure the door to the housing via a lock. Next, a user can select an application or a feature of the smart device to be shown/accessible from the display screen using the display screen. A user can also use a phone handset of the device to make or answer a phone call from the smart device through the device.

Accordingly, the cell phone docking station device of the present invention is particularly advantageous as it provides a device that can be used to reduce distractions caused by cell phones. More specifically, the device reduces distractions from cell phones by limiting cell phone access, while still allowing a user to access important features of the cell phone through the device. In addition, the specific features of the cell phone that are accessible through the device can be customized by the user. In this manner, the cell phone docking station device overcomes the limitations of existing headstones known in the art.

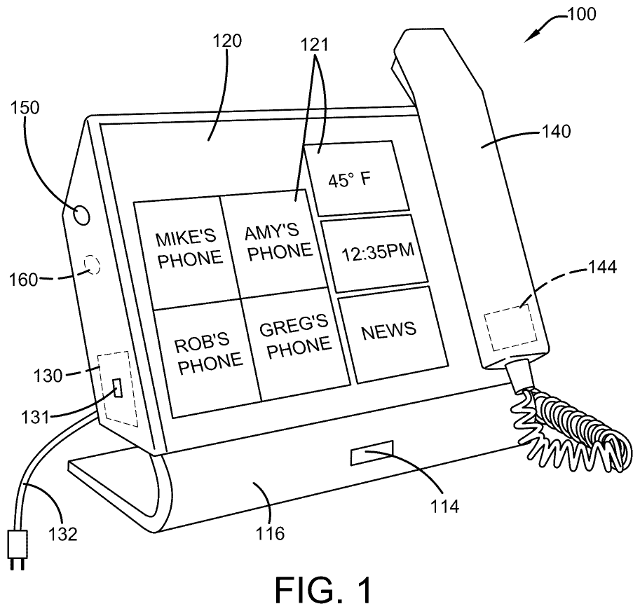

Referring initially to the drawings, FIG. 1 illustrates a front perspective view of one potential embodiment of a cell phone docking station device 100 of the present invention in accordance with the disclosed architecture. The device 100 is comprised of a housing 110 that receives a smart device 10 such as but not limited to a cellphone. The housing 110 is preferably generally rectangular but may be any shape in different embodiments. The housing 110 may also be comprised of a height-adjustable and angle-adjustable (i.e., tilting) stand 116 or base.

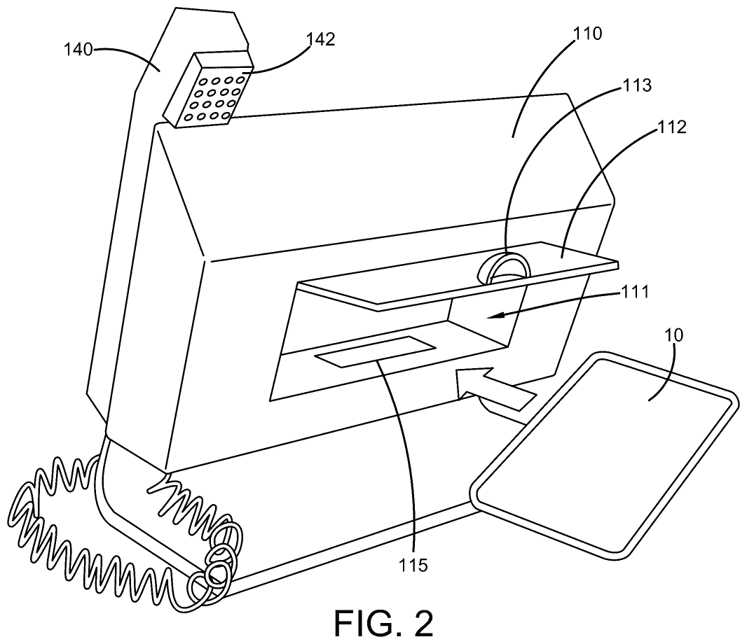

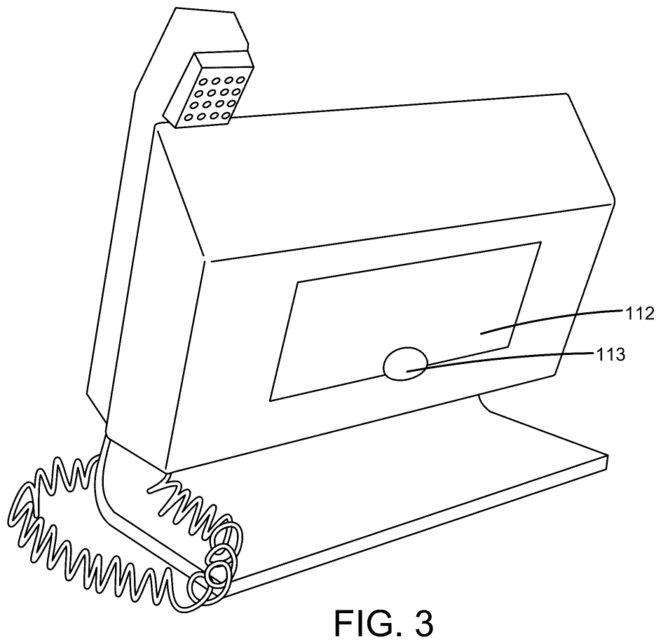

The housing 110 is comprised of at least one compartment 111, as seen in FIG. 2. The compartment 111 is preferably positioned on a rear area of the housing 110. The compartment 111 is comprised of at least one door 112 that covers the compartment 111. The door 112 may be any style of door such as but not limited to a hinged door, a snap-fastener door, etc. In one embodiment, the door 112 is secured to the housing 110 via at least one lock 113 of any type known in the art, as seen in FIG. 3.

The compartment 111 is comprised of at least one charging port 131 positioned within the compartment 111. The charging port 131 may be a wired charging port such as but not limited to a USB or lightning port. The charging port 131 may alternatively be a wireless charging port 131. The port 131 charges a smart device 10 placed within the compartment 111, and also places the smart device 10 in electrical communication with at least one display screen 120 on the housing 110.

The screen 120 may be any type of electronic display screen, including but not limited to a touchscreen. The screen 120 can be programmed by a user to display specific applications 121 and/or features of the smart device 10, such that the user is not distracted by unnecessary applications/features of the smart device 10, and wherein a user cannot access the smart device 10 when within the compartment 111. As a result, the device 100 reduces the distractions associated with using a smart device 10 without causing a user to lose out on important functions of a smart device 10. For example, the screen 120 may be configured to only display phone calls, text messages, and emails from the smart device 10 (and no other notifications/alerts). The screen 120 also allows a user to silence specific features and/or notifications as needed.

In one embodiment, audio (ex. phone calls, notifications, sounds, etc.) from the smart device 10 can be played via at least one speaker 114 of the housing 110 through electrical communication via the charging port 131. Volume of the speaker 114 may be controlled and configured by the display 120 and/or at least one button 150. In one embodiment, a user can take a phone call from the smart device 10 through at least one wired or wireless phone handset 140 removably docked on the housing 110, wherein the handset 140 is comprised of at least one speaker 142 and at least one microphone 144.

Components of the device 100 are powered by at least one battery 130. In one embodiment, the battery 130 is not removable from the housing 110 and can receive continuous power via at least one power cord 132 (such as but not limited to a male wall plug). In another embodiment, the battery 130 may be removable or non-removable and rechargeable by at least one charging port 115 such as but not limited to a USB port.

The device 100 may also be comprised of at least one transmitter 160. The transmitter 160 may be a Bluetooth or Wi-Fi transmitter that allows the device 100 to integrate with other smart home features.

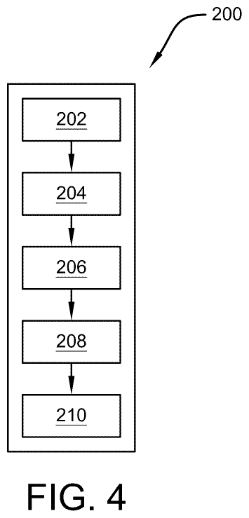

The present invention is also comprised of a method of using 200 the device 100, as seen in FIG. 4. First, a device 100 is provided comprised of housing 110 comprised of a compartment 111 comprised of a charging port 115, a display screen 120, and a phone handset 140 [Step 202]. Then, a smart device 10 can be placed inside the compartment 111 and attached to the charging port 115 [Step 204]. Next, a user can close the compartment 111 with the smart device 100 inside via the door 112 and can then secure the door 112 to the housing 110 via a lock 113 [Step 206]. Next, a user can select an application 121 or a feature of the smart device 100 to be shown/accessible from the display screen 120 using the display screen [Step 208]. A user can also use a phone handset 140 of the device 100 to make or answer a phone call from the smart device 10 through the device 100 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cell phone docking station device” and “device” are interchangeable and refer to the cell phone docking station device 100 of the present invention.

Notwithstanding the forgoing, the Cell phone docking station device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the Cell phone docking station device 100 as shown in the FIGS. are for illustrative purposes only, and that many other sizes and shapes of the Cell phone docking station device 100 are well within the scope of the present disclosure. Although the dimensions of the Cell phone docking station device 100 are important design parameters for user convenience, the Cell phone docking station device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cell phone docking station device comprising:
a housing comprised of:
a display screen;
a compartment comprised of a charging port in electrical communication with the display screen; and
a phone handset comprised of a speaker and a microphone.

2. The cell phone docking station device of claim 1, wherein the charging port is comprised of a wired charging port.

3. The cell phone docking station device of claim 2, wherein the charging port is comprised of a USB port.

4. The cell phone docking station device of claim 1, wherein the display is comprised of a base.

5. The cell phone docking station device of claim 3, wherein the base is comprised of a height-adjustable base.

6. The cell phone docking station device of claim 3, wherein the base is comprised of a tilt-adjustable base.

7. The cell phone docking station device of claim 1, wherein the compartment is comprised of a door.

8. The cell phone docking station device of claim 6, wherein the door is secured to the housing via a lock.

9. The cell phone docking station device of claim 1, wherein the display screen displays an application of a smart device.

10. A cell phone docking station device comprising:
a housing comprised of:
a touchscreen display screen;
a first speaker;
a battery;
a compartment comprised of a lock and a first charging port in electrical communication with the touchscreen display screen;
a phone handset comprised of a second speaker and a microphone; and
a transmitter.

11. The cell phone docking station device of claim 10, wherein the first charging port is comprised of a wireless charging port.

12. The cell phone docking station device of claim 10, wherein the transmitter is comprised of a Wi-Fi transmitter or a Bluetooth transmitter.

13. The cell phone docking station device of claim 10, wherein the phone handset is comprised of a wired phone handset.

14. The cell phone docking station device of claim 10, wherein the phone handset is comprised of a wireless phone handset.

15. The cell phone docking station device of claim 10 further comprised of a power cord.

16. The cell phone docking station device of claim 10, wherein the battery is comprised of a second charging port.

17. The cell phone docking station device of claim 16, wherein the battery is removable from the housing.

18. The cell phone docking station device of claim 10, wherein the display screen displays an application of a smart device, wherein the smart device is in electrical communication with the first charging port.

19. A method of using a cell phone docking station device, the method comprising the following steps:
providing a cell phone docking station device comprised of a device comprised of housing comprised of a compartment comprised of a charging port, a display screen, and a phone handset;
placing a smart device inside the compartment and attaching the smart device to the charging port;
closing the compartment with the smart device inside via a door and securing the door to the housing via a lock;
selecting an application of the smart device to be accessible from the display screen using the display screen; and
using the phone handset to make or answer a phone call from the smart device.

20. The method of using a cell phone docking station device of claim 19, wherein the display screen is comprised of a touchscreen.
